(19) United States
(12) Patent Application Publication
(10) Pub. No.: US 2011/0175344 A1
(43) Pub. Date: Jul. 21, 2011

(54) Reflective tool size dimension stickers

(76) Inventor: Jeffrey Sackley, Golden, CO (US)

(21) Appl. No.: 12/657,179

(22) Filed: Jan. 19, 2010

(51) Int. Cl. B42D 15/00; B31B 49/00

(52) U.S. Cl. 283/81; 493/324

(57) ABSTRACT

A labeling sticker for the visual identification of a tool having a corresponding working dimension working size is provided. The sticker includes a base sheet having a releasable surface, a sheeting adhered to the base sheet having a reflective printable surface and a metal bonding adhesive layer, and a numeric size indicia printed on the reflective surface which correlates to the working size of the tool to be identified.

### CROSS REFERENCE TO RELATED APPLICATIONS

Not applicable.

### STATEMENT OF FEDERALLY SPONSORED RESEARCH

Not applicable.

### BACKGROUND OF THE INVENTION

1. Field of the Invention

The present invention relates to tool size identification. In particular, it relates to reflective tool size identification stickers for easy visual identification and location of a specifically sized tool.

2. Description of the Related Art

Hand tool identification systems, for identifying individually sized tools, are well known. Tools are typically sold in a wide variety of configurations and sizes and include sockets, hand wrenches, and set screw keys sized in numerical units corresponding to the working size of the fastener to be worked.

The tools are generally manufactured with the working size of the tool etched thereon so that the worker may differentiate the actual size difference between tools. However, the actual size difference between tools is often very slight, requiring the worker to read the respective marking on a number of tools in order to find the correctly sized tool for the desired fastener. As a result, persons have conceived of various means for overcoming the difficulty in finding the correctly sized tool for the fastener.

For example, U.S. Pat. No. 5,031,488, to Zumeta, discloses a color coding system primarily for hand tools. This system relies on a color coded application where all tools having a size of one or more exact inches are of the labeled with the same color. The colors are then applied as bands to the tool for identification.

Another such example is disclosed in U.S. Pat. No. 5,079,978, issued to Kupfer. There, a combination of two sets of wrenches and sockets, each identifiable for size, is disclosed with each set calibrated according to a different measuring system together with a process for identifying the size and the measuring systems by indicia specific to each size and to each system of measurement. This system uses a lined based etched indicia for identification by size or touch.

Another such example, U.S. Pat. No. 5,330,230, issued to Craig, discloses a kit for identifying individually sized tools such as sockets. This kit is designed to facilitate visual identification of the individual tools, and includes a substrate which supports a numerical legend and a predetermined number of bands or strips each having a particular color. The colored bands or strips are adhesively affixed on tools, such as sockets, of a particular size. The color of each band or strip correlates with a socket size which is expressed on the legend for comparison by association.

While the foregoing example offers some utility, a major disadvantage with each lies in the fact that, while they do provide for a visual or tactile identification of an individually sized tool, they require comparison by association of a line or color coded indicia for sized identification of the tool. Another disadvantage with each is that observation and association of the color and line based indicia would prove difficult in the low light conditions which are often encountered when constructing or repairing mechanical systems. In addition, the above systems do not assist in the location of a lost or misplaced tool when working in dark or tight locations, such as dropped socket in an engine compartment, with a flashlight. Thus, it is desirable to provide a tool identification sticker with commonly large commonly used English or metric equivalent numerical designation indicia for bonding to the external surface of a tool or set of tools. It is also desirably to provide a tool identification indicia which is also easily observed from any angle and is reflective in order to easily differentiate tool size under low light conditions and to assist in the location of lost or misplaced tools with a flashlight. The present invention satisfies these needs.

### BRIEF SUMMARY OF THE INVENTION

It is therefore an object of the present invention to provide a tool identification sticker with commonly used English or metric equivalent numerical designation indicia for bonding to the external surface of a tool, or set of tools.

It is another object of the present invention to provide a tool identification sticker which is easily observed from any angle of view.

It is another object of the present invention to provide a reflective tool identification indicia in order to easily to differentiate specifically sized tools under low light conditions.

It is yet another object of the present invention to provide tool identification indicia which serves to assist in the location lost or misplaced tools with a flashlight.

To overcome the problems associated with the prior art methods, and in accordance with the purpose of the present invention, as embodied and broadly described herein, briefly a labeling sticker for the visual identification of a tool having a corresponding working dimension is provided which includes a base sheet having a releasable surface, a sticker sheeting adhered to the base sheet having a reflective printable surface and a metal bonding adhesive layer, and a numeric size indicia printed on the reflective surface which correlates to the working size of the tool to be identified.

Additional advantages of the present invention will be set forth in part in the description that follows and in part will be obvious from that description or can be learned from practice of the invention. The advantages of the invention can be realized and obtained by the apparatus particularly pointed out in the appended claims.

### BRIEF DESCRIPTION OF THE SEVERAL VIEWS OF THE DRAWINGS

The accompanying drawings, which are incorporated in and which constitute a part of the specification, illustrate at least one embodiment of the present invention, and together with the description explain the principles of the invention.

FIG. 1 is a perspective view of the present invention adhered to a set of sockets, showing the preferred of the stickers having three copies of the numerical indicia so that the socket size is seen from any point about the circumference of the socket.

FIG. 2 is a page view showing a preferred embodiment of the present invention when printed with three copies of the specific numerical indicia on a sheet of stickers each sized in length to fit around the circumference of the tool to be identified.

FIG. 3 is a page view showing a preferred embodiment of the present invention when printed with three copies of the specific metric numerical indicia on a sheet of stickers each sized in length to fit around the circumference of the tool to be identified for a ½ and ⅜ inch drive.

FIG. 4 is a page view showing a preferred embodiment of the present invention when printed with three copies of the specific English numerical indicia on a sheet of stickers each sized in length to fit around the circumference of the tool to be identified for a ⅜ and ¼ inch drive.

### DETAILED DESCRIPTION OF THE INVENTION

Unless specifically defined otherwise, all technical or scientific terms used herein have the same meaning as commonly understood by one of ordinary skill in the art to which this invention belongs.

Although any of the methods and materials similar or equivalent to those described herein can be used in the practice or use of the present invention, the preferred methods and materials are now described. Reference will now be made in detail to the presently preferred embodiments of the invention, examples of which are illustrated in the accompanying drawings wherein like numerals represent like features of the invention.

The invention provides a tool identification sticker with commonly used English or metric equivalent numerical designation indicia for bonding to the external surface of a tool, or set of tools. The sticker is useful for the visual identification of a tool having a corresponding working dimension with the labeling indicia. The labeling sticker 10 is adhered to a base sheet 20. The sticker 10 has a pressure sensitive adhesive coating in order to bond the sticker 10 to an outer circumference of a barrel the tool 30 to be identified.

The stickers 10 are produced from any reflective sheeting, which is well known, intended for production of stickers capable of bondable to a metal surface and conformable to a circumference without memory in order to avoid peeling after bonding. In a preferred embodiment the sticker 10 is desirably produced from an engineering, or commercial, grade durable enclosed lens pressure sensitive adhesive coated sheeting. The sheeting may, but need not, include a release liner protecting the printable surface for removal prior to printing. The foregoing sheeting is commonly of a type intended for use in the production of non-critical signs or stickers where reflectivity is required. In a preferred embodiment, the coefficient of retroreflection (R̂) is desirably conforming in a range of 20 to 60 at 0.2° observation and −4° entrance, as measured per ASTM E810, and reported in candelas per lux per square meter or candles per foot candle per square foot, and are colored in either white, yellow or orange. The stickers 10 may be either applied either by hand, roller, or machine.

The stickers 10 are preferably printed and sized in a series 21 with the specific numerical indicia 11 representative of the tool 30 having a working dimension of a size in the series 21 to be identified in either English or metric units. The indicia 11 is desirably printed in boldface black on the sheeting either by screen printing, digital thermal transfer printing, or ink jet printing. With screen or ink jet printing, it is desirable to use the commercial grade reflective sheeting manufactured by 3M™ and sold under the designation Series 3200CG and 3M™ Process Colors Series 990 or 8801. For thermal printing, it is desirable to use the commercial grade reflective sheeting for thermal transfer printing manufactured by 3M™ and sold under the designation Series 3200DP using 3M™ Thermal Transfer Ribbons Series TTR2300.

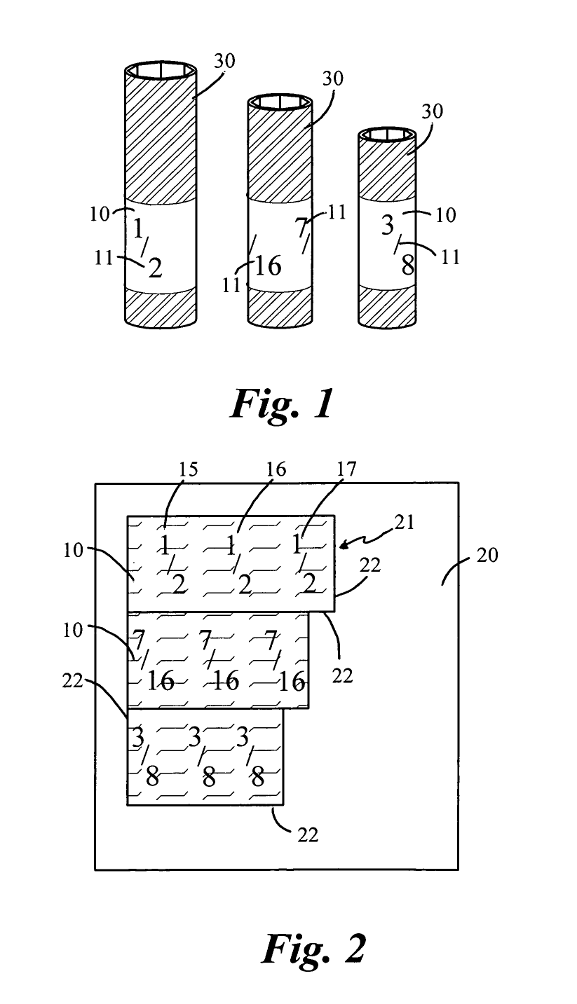

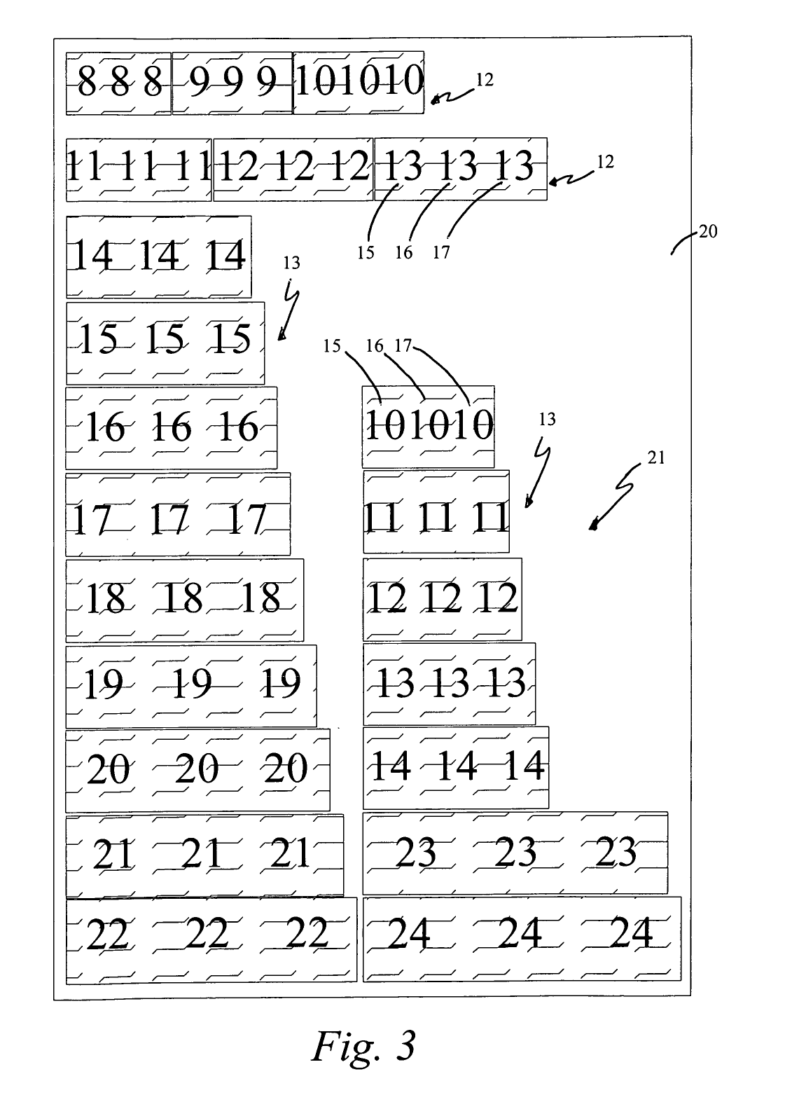

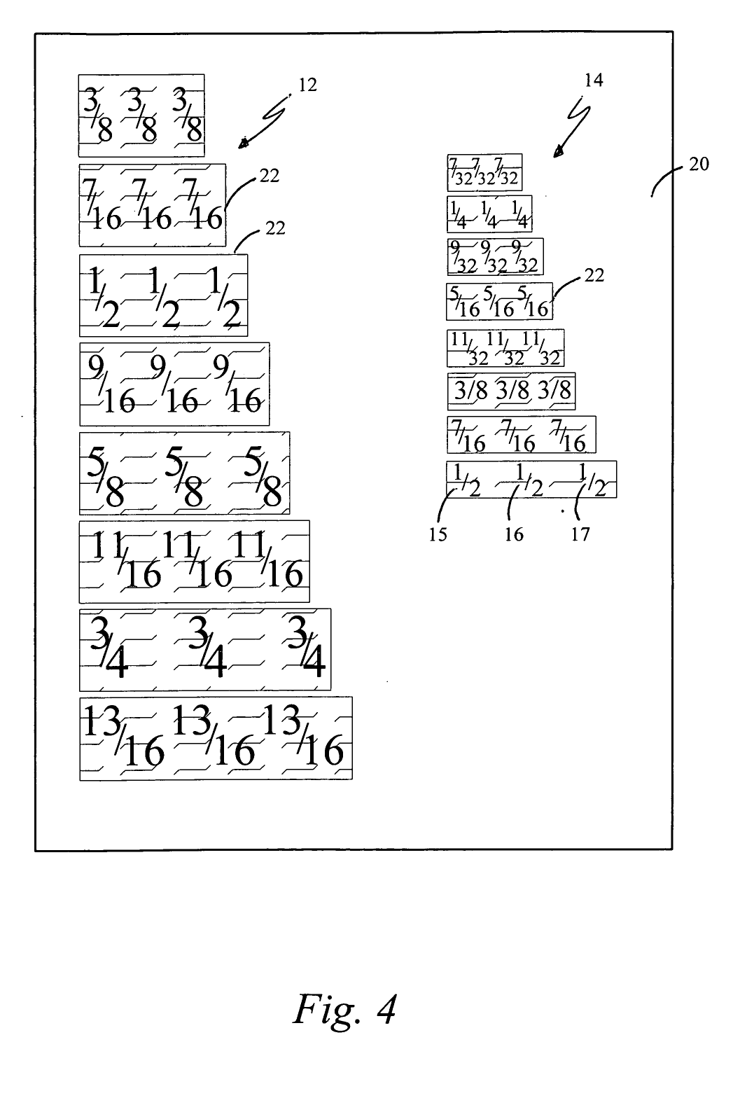

Referring now to FIGS. 2, 3 and 4, in the preferred embodiment of the present invention, a plurality of the stickers 10 are printed in a series 21 on a larger reflective sheet 20 so that the size and indicia representation of each of the stickers 10, on the sheet 20 corresponds with a respective working dimension for each of the tools 30 in a set, such as a set of ½ inch 13, ⅜ inch 12 and ¼ inch 14 ratchet drive shallow or deep sockets for use with either English or metric fasteners. In this manner, the sheet 20 of stickers 10 includes cutoff lines 22 defining an area for each individual sticker 10, of the series 21, for separating the stickers 10 along their respective top, bottom and side margins prior to application of the sticker 10 to the correspondingly specific tool 30, to be identified. It is desirable to print each sticker 10 of the series 21 in a cutoff length which circumscribes the entire outer diameter of the socket tool 30 to be identified. Thus, each sticker 10 in the series 21 has a proportionate printable length which is equal to c=π×d where d is the predetermined diameter of the barrel of the tool and c is the outer circumference of the correspondingly sized socket tool to be identified, and the side margins are defined by cutoff lines scaled accordingly. In addition, the top and bottom cutoff lines are preferably sized in height according to a predetermined height of the barrel of the socket, or tool, to be identified. It is also best to print the numerical reference indicia in copies of three 15, 16, 17 so that they are evenly spaced along the scaled length of the sticker 10 so that the tool working dimension is easily viewed from any angle, as demonstrated in FIG. 1.

In use, one simply selects a sheet 20 of stickers 10 having a series 21 of indicia representations corresponding with the tools 30 in a set which one desires to mark. Next, it is desirable to properly prepare the outer surface of the tools 30 by cleaning with a solution compatible with the specific metal substrate of the tool, such as an alcohol solution. Then, one simply cuts the stickers 10 along the cutoff lines 22, peels the stickers 10 from the backing, and rolls the stickers 10 onto the outer circumference of the tool 30 in order to bond the sticker 10 to the tool 30 for easy observation and identification.

While the present invention has been described in connection with the embodiments as described and illustrated above, it will be appreciated and understood by one of ordinary skill in the art that certain modifications may be made to the present invention without departing from the true spirit and scope of the invention, as broadly described and claimed herein.

I claim:

1. A labeling sticker for the visual identification of a tool having a corresponding working dimension, comprising:
(a) a base sheet having a releasable surface;
(b) a sticker sheeting adhered to the base sheet having an upper reflective printable surface and a lower metal bonding adhesive layer; and
(c) a numeric size indicia printed on the reflective surface which correlates to the working dimension of the tool to be identified.

2. The labeling sticker according to claim 1, wherein the sticker has a length which is substantially equal to 3.14 times a diameter of a barrel of the tool to be identified.

3. The labeling sticker according to claim 1, wherein the base sheet includes a plurality of the labeling stickers set forth in a predetermined series which corresponds to a predetermined series of tool working dimensions.

4. The labeling sticker according to claim 1, wherein the reflective surface is screen, thermal transfer, or ink jet printable.

5. The labeling sticker according to claim 1, wherein the sticker sheeting is a durable enclosed lens retroreflective sheeting.

6. The labeling sticker according to claim 1, wherein the sticker sheeting has a coefficient of retroreflection (RA) conforming in a range of 20 to 60 at 0.2° observation and −4° entrance in candelas per lux per square meter or candles per foot candle per square foot.

7. The labeling sticker according to claim 1, wherein the sticker sheeting is colored in either white, yellow or orange.

8. The labeling sticker according to claim 1, wherein the tool is a socket.

9. The labeling sticker according to claim 2, wherein the labeling indicia is three evenly spaced copies of a numerical value representing a working dimension of the tool to be identified.

10. A system for the reflective visual identification of a tool in a series having a corresponding working dimension, comprising the steps of:
(a) providing a base sheet having a releasable surface;
(b) providing a plurality of stickers including a sheeting adhered to the base sheet having an upper reflective printable surface and a lower metal bonding adhesive layer;
(c) providing a numeric size printed indicia on the reflective surface which correlates to the working dimensions of each of the tools in the series to be identified.
(d) separating the stickers along the cutoff line;
(e) peeling the stickers from the base sheet; and
(f) bonding the stickers about a barrel of the tool in the series having the respective working dimensions which correlates to the indicia printed on the reflective surface.

11. The system according to claim 10, wherein the each of the stickers in the series has a length which is substantially equal to 3.14 times a diameter of a barrel of the tool to be identified.

12. The system according to claim 10, wherein the reflective surface is screen, thermal transfer, or ink-jet printable.

13. The system according to claim 10, wherein the sticker sheeting is a durable enclosed lens retroreflective sheeting.

14. The system according to claim 10, wherein the sticker sheeting has a coefficient of retroreflection (RA) conforming in a range of 20 to 60 at 0.2° observation and −4° entrance in candelas per lux per square meter or candles per foot candle per square foot.

15. The system according to claim 10, wherein the sticker sheeting is colored in either white, yellow, or orange.

16. The system according to claim 10, wherein the tool is a socket.

17. The labeling sticker according to claim 11, wherein the labeling indicia is three evenly spaced copies of a numerical value representing the working dimension of the tool to be identified.
